(19) United States
(12) Patent Application Publication
(10) Pub. No.: US 2026/0336552 A1
(43) Pub. Date: Oct. 29, 2026

(54) Transport Means, Assembly and Method for Categorizing a Passenger of a Transport Means

(71) Applicant: Bayerische Motoren Werke Aktiengesellschaft, Muenchen (DE)

(72) Inventors: Simone CAMBERG, Muenchen (DE); Thomas EWENDER, Muenchen (DE); Johannes FELDMAIER, Ebersberg (DE); Florian OBER, Reichersbeuern (DE)

(21) Appl. No.: 19/099,019

(22) PCT Filed: Jun. 30, 2023
(86) PCT No.: PCT/EP2023/068088

§ 371 Date: Jan. 27, 2025

(30) Foreign Application Priority Data
Aug. 29, 2022 (DE) 10 2022 121 814.7

(51) Int. Cl. B60R 21/015; B60N 2/00; B60N 2/02; B60R 21/00; G06V 10/774; G06V 20/59; G06V 40/10

(52) U.S. Cl. CPC B60R 21/01538; B60N 2/0025; B60N 2/0026; B60N 2/0027; G06V 10/774; G06V 20/593; G06V 40/10; B60N 2/02246; B60R 2021/006

(57) ABSTRACT

A method for categorizing a passenger of a transport means includes ascertaining an electrical signal of a motor for adjusting a passenger seat. The passenger is detected via an optical sensor for generating an image. The electrical signal and the image are compared with a respective reference. The passenger is categorized as a child-on-a-child-seat or as an adult based on a result of the comparison.

### BACKGROUND AND SUMMARY

The present invention relates to an assembly, to a transport means, and to a method for categorizing a passenger of a transport means. In particular, the present invention relates to an implementation of an automatic categorization of a passenger, for example in order to switch off an air bag, which implementation is simple with respect to the hardware.

Under certain circumstances, air bags in transport means must be switched off or automatically deactivated in order to avoid becoming a safety risk themselves in the case of an impact. For example, air bags are not permitted to be switched on when a child seat facing away from the direction of travel is mounted and occupied on the seat in question. In many countries, it is a legal requirement that air bags be switched off automatically in certain usage scenarios. In the prior art, in order to detect an occupied seat, a sensor pad in the seats is used to establish the occupancy state and the mass/passenger category. Whereas an air bag is prevented from being triggered when a seat is unoccupied, the air bag is ignited if necessary when seats are occupied by an adult. If children have become seated (with booster seats, if necessary) on the seat in question, an air bag is also usually prevented from being triggered. In the case of an unoccupied seat, a backwards-facing child seat, and/or a passenger who is three to six years old, an air bag associated with the seat is not ignited, otherwise it is generally ignited.

The sensor pads in the seat are a piece of hardware that increases the vehicle mass, the seat complexity, and the costs for the transport means. In addition, wiring must be configured to conduct the sensor pad signals. If a sensor pad concept, which is also referred to as a “Passive Occupant Detection System (PODS)”, is omitted, a purely camera-based passenger identification poses the problem that it is difficult to differentiate between a six-year-old child on a booster seat and a petite woman based purely on an image, since the use of the booster seat can result in an erroneous estimation of the body size. In addition, the booster seat can be optically concealed and, therefore, cannot be detected using the camera (concealed by clothing, for example, a dress, a skirt, a blanket, or other accessories), such that a correction cannot be made on the basis of optical signals.

Proceeding from the aforementioned prior art, the present invention is based on at least the object of implementing a correct passenger classification and an optional switch-off of the air bag using the simplest hardware possible, in particular in a hardware-neutral manner. At least this object is achieved by the systems, methods and devices described herein.

The invention generally relates to a categorization of a passenger (for example, a driver, a front passenger, a rear passenger, or the like) of a transport means (for example, a passenger car, a van-type truck, a motorcycle, a truck, an aircraft and/or a watercraft). The categorization can classify the passenger in particular in such a way that, in the case of an impact, a decision whether or not to ignite an air bag is made on the basis of the passenger category.

In a first step, an electrical signal of a motor for adjusting a seat on which the passenger sits is ascertained. The electrical signal can be, for example, a current value, a power consumption, a thermal characteristic value, a torque, a force (the latter two, for example, via a sensor on a shaft and/or on an electric motor), or the like. The motor can be used, in particular, to generate the electrical signal. For example, the current value can be the current consumption during the adjustment of the seat at a point in time at which the passenger is sitting on the seat with full weight, or with a weight reduced by the weight force of his/her legs located in the footwell. For this purpose, a slight, in particular short, seat adjustment in the manner of a comfort access can be carried out, by means of which the seat is adjusted for the passenger, after boarding, from a rearward position into a position further forward in order to facilitate the access and, thereafter, to optimize the seat position for the upcoming trip.

In a further step, the passenger is optically detected by means of an optical sensor (for example, an interior camera of the transport means) in order to store an image of the passenger (optionally as a moving image or a video). In particular, a digital representation of the image can be created in the process.

In a further step, the electrical signal of the motor and the image are compared with a respective reference. In particular, the reference may have been trained or learned in preceding steps. In any case, the reference is suitable for estimating (ascertaining), on the basis of the electrical signal of the motor, a mass of the passenger and for classifying the position of the passenger at least in terms of whether it is suitable for ascertaining the mass on the basis of the electrical signal of the motor. In other words, the reference can provide information as to whether the picture of the passenger suggests that the passenger has assumed a normal sitting position, such that it can be ruled out that the limbs of the passenger are used to move his/her mass into regions of the vehicle interior other than into the seat surface and the footwell. In this way, it can be ensured that the current passenger on the seat has a mass which can be sufficiently exactly represented by means of the sensor pad of the seat and/or by means of the electrical signal of the motor.

The passenger is subsequently categorized or classified depending on a result of the comparison. In other words, it is established whether there is a child in a child seat and/or on a booster seat, or whether this is an adult. This categorization/classification can also be carried out automatically. In particular, a signal can be output, by means of which automatic, further measures can be initiated depending on the categorization. A sensor pad for the seat can be omitted in this way, as a result of which the transport means can be designed to be more lightweight, lower-cost, and less susceptible to error.

The motor for adjusting the seat can be, in particular, an electric motor, most preferably a brushless DC motor. These motors can be used, depending on their current consumption, to ascertain the torque and, via the torque, the mass of the passenger. In particular, a brushless DC motor can also output or reveal further electrical characteristic values/operating variables in order to ascertain the mass of the passenger.

Preferably, a machine-based learning algorithm (ML) can be used in order to design the method according to the invention to be more robust and more efficient. In one further step, therefore, an optical sensor can be presented with a multitude of test persons which are optically detected, in particular, in a configuration corresponding to that which will be present later in the vehicle. For example, the optical sensor can be located at a position similar to that of the interior camera in the vehicle, which position is used to optically detect the passenger.

Similarly, the seat can also be correspondingly configured during the training (learning process). The perspective and the distance can be designed to be substantially identical to the production car. The mass of the test persons can be ascertained in a conventional method by means of a scale and communicated to the machine-based learning algorithm for the respective test person. In this way, the machine-based learning algorithm, which estimates a weight on the basis of the electrical signal of the motor and/or the images of the passengers, can establish the circumstances under which the estimated mass sufficiently matches the actual mass. The constellations made up of the electrical signal and the position of the passenger in the image can be subsequently used to categorize the training data set as “permissible” when the mass of the test person, which has been determined by means of the electric motor and the optical signal, sufficiently matches the actual mass. In other words, the training data set can be assessed as permissible when a mass of the test person, which has been determined by means of the electric motor, sufficiently matches the training data set. Therefore, without using the data of the sensor pad, a sufficiently valid estimation of the mass of a passenger can be carried out, by means of which the passenger can be categorized as a “child” or as an “adult”.

In a further step, the training data set considered to be permissible can be used as a predefined reference for a valid categorization on the basis of the electrical signal. In other words, the learned training data set can represent the predefined reference or be used as an integral part of the predefined reference, which has already been introduced above.

When the electrical signal is compared with the predefined reference, in particular a posture can be detected by means of the optical sensor. In other words, the extent to which the posture affects the mass ascertained by means of the electrical signal can be established. If the posture is a typical posture in which only a portion of the weight of the passenger is introduced into the footwell, while the main portion can be introduced into a seat surface (and backrest) of the seat, an electrical signal of the motor can be assessed as “representative” with respect to the mass of the passenger and used for a valid determination of the mass. The reference can also characterize a posture, however, in which the passenger is kneeling, for example, on the seat surface, is considerably supported on the center console of the transport means or anywhere else, such that the electrical signal, which has been determined by means of the motor, does not represent the actual weight of the passenger. In this case, the determination of the electrical signal can be repeated at a later point in time, and the electrical signal which has then been determined can be used to determine the mass of the passenger, provided the image of the passenger does not represent an abnormal posture. In this way, the mass of a passenger can be successfully determined on the basis of the electrical signal of an electric motor even without a pressure sensor/a sensor pad.

As a final step, the method according to the invention can be concluded by switching off an air bag for the seat when the seat is occupied and the category is “child on a child seat.” In this case, an air bag is not triggered when the transport means is involved in a sufficiently serious accident. Otherwise (the category is “adult on the seat”), the air bag is activated and, in the case of an impact, ignited as intended, in order to protect the passenger.

According to at least one embodiment, an assembly for categorizing a passenger of a transport means is provided. The assembly includes a data input, an evaluation unit, and a data output. The aforementioned elements of the assembly can be designed as an electronic control device. The transport means can be in the form of a passenger car, a transporter, a motorcycle, a truck, an aircraft, and/or a watercraft. The evaluation unit is designed to ascertain, by means of the data input, an electrical signal of a motor for adjusting a seat on which the passenger sits. In addition, the evaluation unit is designed to detect the passenger in order to generate an image, or to ascertain an image of the passenger, by means of the data input (for example, in connection with an optical sensor). The electrical signal and the image can be subsequently compared with a respective reference and, depending on a result of the comparison, the evaluation unit categorizes the passenger, by means of the data output, as a “child on a child seat” or as an “adult”. Depending on the category, the evaluation unit can then also automatically deactivate or activate an air bag of the transport means via the data output. Therefore, the assembly is able to achieve the features, the combinations of features, and the advantages resulting therefrom so evidently in a corresponding manner that reference is made to the aforementioned comments in order to avoid repetition.

According to at least one embodiment, a transport means is provided, which transport means has the assembly described herein. In this way, the transport means can also achieve the features, the combinations of features, and advantages in a corresponding manner.

At least one embodiment will now be described with reference to the drawings.

### BRIEF DESCRIPTION OF THE DRAWINGS

FIG. 1 is a schematic view of a transport means having an assembly according to at least one embodiment; and

FIG. 2 is a flow chart illustrating a method according to at least one embodiment.

### DETAILED DESCRIPTION OF THE DRAWINGS

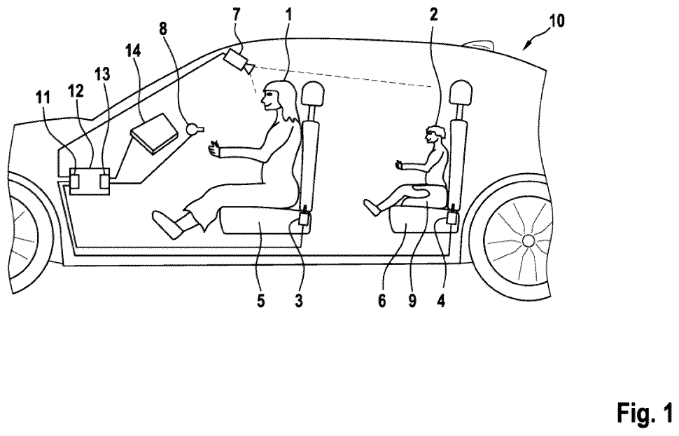

FIG. 1 shows a passenger car as a transport means 10, in the first row of seats of which a front passenger, as a passenger 1, has taken a seat on a front passenger seat, and a child, as a passenger 2, has taken a seat on a back seat 6. The child 2 is sitting on a booster seat 9. The seats are adjustable by means of electric motors 3, 4. Depending on the masses, or passengers 1, 2, located on the seats, the currents consumed by the electric motors 3, 4 are of different levels and can therefore be used to determine the masses of the passengers 1, 2. An interior camera 7 is oriented such that both passengers 1, 2 are optically detected to the fullest extent. On the basis of the data of the interior camera 7, a posture of the passengers 1, 2 and the presence of the booster seat 9 can be established. This information or pictures/images of the passengers 1, 2, as well as the input variables of the electric motors 3, 4, are fed via a data input 11 to an evaluation unit 12 in the form of an electronic control device. Via the data output 13 of the control device, an air bag 8 is switched off or reactivated and, if necessary, a message is output on a central information screen 14. The message can provide information, for example, about the automatic activation/deactivation of the air bag 8.

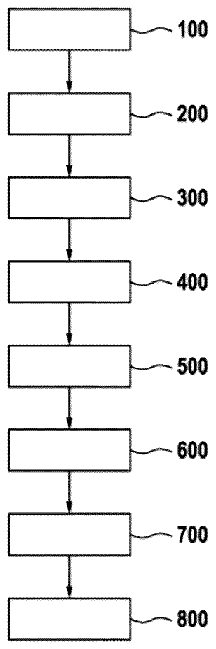

FIG. 2 shows steps of an exemplary embodiment of a method according to the invention for categorizing a passenger of a transport means. In step 100, a machine-based learning algorithm is trained by presenting different test persons to an optical sensor and linking these to the respective actual mass thereof in order to create a training data set. In other words, the machine-based learning algorithm is presented with a first test person on a seat similar to that of the vehicle and the mass of the test person, which has been ascertained (for example, by means of a scale), is made known. In step 200, a mass of the test person is determined by means of an electric motor in the seat, in order to supplement the training data set. The kinematics and the motor as well as the spatial relationships between the sensors and the seat/the passenger can correspond to those of the production car. In step 300, the training data set is subsequently assessed as permissible when a mass of the test person, which has been determined by means of the electric motor, sufficiently matches the training data set. Feedback is therefore provided regarding whether the image of the in the test person and the mass ascertained by means of the electrical signal “match” the actual mass of the test person. If this is the case, the training data set is used to define the predefined reference and the production car is equipped with the predefined reference. In step 400, an electrical signal of a motor for adjusting a seat, on which the passenger of the transport means sits, is subsequently ascertained. The electrical signal can be, for example, an input current of the motor. In step 500, in addition, the passenger is detected by means of an optical sensor in the form of an interior camera of the transport means for generating an image, or a picture, of the passenger. In step 600, the electrical signal is subsequently compared with a first reference and the image of the passenger is compared with a second reference and, depending on a result of the respective comparison, the passenger is categorized as a “child” or as an “adult”. In particular, on the basis of a seat size of the child, it can be inferred that the child is located on a child seat, or on a booster seat and, therefore, the air bag of the transport means is to be automatically deactivated. In step 700, the passenger is categorized as a “child on a child seat”. Finally, in step 800, an air bag for the seat is switched off when the seat is occupied and the category is “child on a child seat”.

The method is preferably be designed as a machine-based learning method. This can be divided into two basic phases: (1) acquiring and labeling training data, and (2) implementation.

The phase of acquiring and labeling training data preferably includes obtaining camera shots of test persons of a known weight, and determining a ground truth regarding measured weight. When the weight measured via electric motors is within a defined range about the actual weight (for example, ±5 kg), the data set is a positive class, otherwise the data set is a negative class.

The phase of implementation preferably includes determining the class as an output of the machine learning-based method, for example, of the neural network. As soon as the person has been classified in a positive class, the weight measurement is carried out using an electric motor. An even simpler method could be reserved as a basic/fallback option. In this case, a use of training data would be applied, which uses the typical out-of-position sitting positions and permissible (in-position) sitting positions.

Therefore, a sensor pad can be dispensed with for detecting seat occupancy or classifying passengers, as a result of which vehicles can be designed to be less expensive, more lightweight, and less susceptible to error.

### LIST OF REFERENCE SIGNS

1, 2 passenger
3, 4 electric motor
5, 6 seat
7 interior camera
8 air bag
9 booster seat
10 transport means
11 data input
12 evaluation unit
13 data output
14 central information display
100-800 method steps

1-11. (canceled)

12. A method for categorizing a passenger of a transport means, comprising:
ascertaining an electrical signal of a motor for adjusting a passenger seat;
detecting the passenger by means of an optical sensor for generating an image;
comparing the electrical signal and the image with a respective reference; and categorizing the passenger as a child-on-a-child-seat or as an adult based on a result of the comparison.

13. The method of claim 12, wherein the motor is a brushless DC motor.

14. The method of claim 12, wherein the electrical signal represents a current or a torque.

15. The method of claim 12, further comprising:
creating a training data set by presenting test persons to a further optical sensor and linking to the respective actual mass of the test data;
training a machine-based learning algorithm using the training data.

16. The method of claim 15, further comprising:
determining a mass of the test person by means of an electric motor of a seat in order to supplement the training data set; and
assessing the training data set as permissible when a mass of the test person, which has been determined by means of the electric motor, sufficiently matches the training data set.

17. The method of claim 16, further comprising:
using the permissible training data set as a predefined reference for a valid categorization on the basis of the electrical signal.

18. The method of claim 12, wherein, when comparing the electrical signal with the reference, a posture is detected by means of the optical sensor, which posture is predefined for a valid ascertainment of the mass of the passenger.

19. The method of claim 12, wherein a signal of a pressure sensor is not incorporated in the comparison.

20. The method of claim 12, further comprising:
switching off an air bag for the seat when the seat is occupied and the category is child-on-a-child-seat; and
switching on the air bag for the seat in all other cases.

21. A system for categorizing a passenger of a transport means, comprising:
a data input;
a data output; and
an evaluation unit configured to:
ascertain, via the data input, an electrical signal of a motor for adjusting a passenger seat,
detect the passenger by means of an optical sensor for generating an image,
compare the electrical signal and the image with a respective reference, and
categorize, via the data output, the passenger as a child-on-a-child-seat or as an adult based on a result of the comparison

22. A transport means including the system of claim 21.
